(19) United States
(12) Patent Application Publication
(10) Pub. No.: US 2019/0289864 A1
(43) Pub. Date: Sep. 26, 2019

(54) SYSTEM FOR CURING AND FLAVOURING FOODSTUFF

(71) Applicant: ELECTROLUX APPLIANCES AKTIEBOLAG, Stockholm (SE)

(72) Inventors: Steve Swayne, Springfield, TN (US); Brendan McGinnis, Springfield, TN (US); Ashish Ainapure, Springfield, TN (US); Kurt Reul, Rothenberg ob der Tauber (DE); Christoph Luckhardt, Rothenberg ob der Tauber (DE); Kersten Kaiser, Rothenberg ob der Tauber (DE)

(21) Appl. No.: 16/302,844

(22) PCT Filed: May 9, 2017
(86) PCT No.: PCT/EP2017/061088

§ 371 Date: Nov. 19, 2018

(30) Foreign Application Priority Data
May 24, 2016 (EP) 16171056.1

(51) Int. Cl. A23B 4/052; A47J 36/32

(52) U.S. Cl. CPC A23B 4/052; A23V 2002/00; A47J 36/32

(57) ABSTRACT

A system for curing or flavouring foodstuff comprising —a smoker unit (2) capable of generating smoke (S), wherein the smoker unit (2) comprises a heating chamber (21); and —a household appliance (1), particularly an oven, comprising a cavity (14) for storing foodstuff and/or a food container (5), the cavity (14) having an outlet opening (6) for supplying the smoke (S) to the cavity (14), wherein the smoker unit (2) is mountable to said household appliance (1) for supplying smoke (S) to said outlet opening (6); and wherein the system further comprises an electric fan (3) arranged for supplying the smoke (S) generated by the smoker unit (2) to the outlet opening (6).

The present invention relates to a system for curing or flavouring foodstuff, a smoker unit, a hose, a food container, and a household cooking appliance, of said system, and a method for flavouring or curing foodstuff.

Smoking of food is commonly known. It is used to achieve a special taste of food and/or cure the smoked foodstuff. Usually specially designed smoking ovens are applied. Such professional smoking ovens can generate the smoke outside of the heating chamber, allowing to cold smoke food. However, these solutions leave the chamber in which the foodstuff is stored during the process with smoke flavour residues, which might be undesirable if other food has to be prepared inside this oven.

Moreover, also from BBQ applications it is known to flavour foodstuff with smoke. Thereby, smoke units can be applied, which are fired with wood. Usually a pot with watered wood chips is placed on top or beside the wooden coal. However, such systems provide for an essentially uncontrolled process, impacted by heat of the glowing coal and air stream inside the barbeque equipment. Thereby, overheating of wood chips may occur, or watered chips may become dry too early, and may even catch fire instead of smoking.

The document U.S. Pat. No. 4,374,489 describes a smoker device adaptable, adjustable and removable to or from a grill or oven. However, the arrangement disclosed in this document does not allow for a controlled smoking process. As the smoke is impacted by heat and air stream inside the grill or oven, particularly the presence of smoke, temperature and/or smell cannot be sufficiently controlled. Moreover, the supplied smoke source, e.g. wood chips, can neither be accessed for control, nor be recharged during the smoking process. The smoke is inserted through a large uninsufated hole into the oven cavity. The smoker device is arranged beneath the lower part of the oven cavity, so that the smoke rises into said oven cavity by natural convection without assisting fan. Since the smoker device has to be attached at a bottom wall of the grill or oven, it is not suitable for build-in ovens. In the most current ovens, the attachment of this smoker device requires substantial alterations of the platform of said oven. Moreover, the smoke cannot be easily directed into a container arranged inside the oven cavity.

Infusing food cooked inside a household oven with smoky flavour or even curing said food with smoke in a household oven is also problematic, as the cooking and/or smoking process, particularly the presence of smoke, temperature and/or smell cannot be sufficiently controlled.

In household appliances, such flavouring of foodstuff with smoke can be done with smoking bags, which are lined on the inside with woodchips. The document F10943713A, for example, describes a smoke bag in which foodstuff to be smoked can be placed. However, such bags have to be heated up to 250° C. to create the wood smoke. So, delicate food can be quickly overcooked. Additionally, due to the closed bag the supplied smoke source, e.g. wood chips, can neither be accessed for control, nor be recharged during the smoking process, without releasing the smoke from the smoke bag. Furthermore, a temperature control of the bag interior is not possible.

The document U.S. Pat. No. 4,232,597 describes a portable smoker. However, this document does not disclose the design of a household cooking appliance, which provides a curing or flavouring function. Moreover, the system disclosed in this document is disadvantageous in that it provides a relatively complicate and protruding arrangement, it cannot be operated without the smoker unit, and particularly, the smoking unit is not accessible during the smoking process for recharging and/or controlling the smoke source. Therefore, such arrangement is not applicable to modern cavity designs of household appliances. The smoke is inserted through a large uninsulated hole into the oven cavity. The smoker unit is arranged at a sidewall of the apparatus, so that the smoke rises into a cabinet by natural convection without assisting fan. Since the smoker unit has to be attached at the side wall of the cabinet, it is not suitable for build-in ovens. In the most current ovens, the attachment of this smoker unit requires substantial alterations of the structure of the apparatus. Moreover, the smoke cannot be easily directed into a container arranged inside the cabinet.

It is an object of the present invention to overcome the above drawbacks and problems.

It is a further object of the present invention to provide a system, particularly a system comprising a household cooking appliance such as an oven, for flavouring and curing foodstuff with smoke. It is a still further object of the present invention to provide such system, which allows for a more controlled smoking process, particularly for controlling smoke presence, temperature and/or smell.

These and other problems are solved by the subject matter of the attached independent claims.

The above objects of the invention are achieved by a system for curing or flavouring foodstuff according to claim 1, a smoker unit according to claim 10, a hose according to claim 11, a food container according to claim 12, a household cooking appliance according to claim 13, and a method according to claim 14.

Preferred embodiments may be taken from the dependent claims.

The above described problems are advantageously solved in a first aspect by a system for curing or flavouring foodstuff according to claim 1 comprises at least a smoker unit, an electric fan and a household appliance.

The above described problems are also advantageously solved in a further aspect by a household cooking appliance according to claim 13. Such household cooking appliance is a household cooking appliance of the system according to the present invention, and may be advantageously manufactured and supplied as a part of the system or as an individual part. The embodiments, features and advantageous described in connection with the household appliance according to the present invention thus shall also be understood to be respective embodiments, features and advantageous of the system according to the present invention, and vice versa.

The household cooking appliance according to the present invention may particularly be an oven, preferably provided with a steam generator, e.g. a steam-cooking oven. Such household cooking appliance comprises a heatable cavity for storing foodstuff, which may be provided in a food container. The cavity of the appliance has an outlet opening for supplying the smoke generated by the smoking unit to the cavity of the appliance.

The outlet opening may be arranged in any of the cavity walls, comprising the sidewalls, back wall, upper wall and lower wall, and the frontal door. However, due to better handling and processing of the smoking process, as well as better handling and processing of other cooking or baking processes to be carried out in the household cooking appliance, it is preferred to arrange the outlet opening in a side wall of the cavity.

Such arrangement is particularly advantageous for the arrangement of a connection, e.g. smoke guiding elements, of the smoking unit and the outlet opening.

In a further advantageous embodiment of the inventive system, the household cooking appliance comprises a control unit configured to operate and/or control smoke supply to the outlet opening. For such purpose the system, particularly the control unit and/or the household cooking appliance may comprise controllable valves. The control unit of the household appliance may be configured to control said valves and/or the operation of the electric fan arranged for supplying the smoke generated by the smoker unit to the outlet opening.

Particularly, the control unit may be configured to operate cooking programs comprising smoking steps. For example, the duration and/or intensity of smoke supply to the foodstuff may be controlled by the control unit, and particularly by such programs. By way of example, the creation of smoke or aroma can be integrated into automatic programs, e.g. to produce a predetermined smoke aroma for a predetermined time period. For example, a program may operate the electric fan or valves 5 min before a cocking program finishes.

The above described problems are also advantageously solved in a further aspect by a method for flavouring or curing foodstuff according to claim 14. Said method according to the present invention comprises at least the following steps:
a) placing a food container having an adapter configured to be connectable to a hose into a cavity of a household cooking appliance comprising a smoker unit and an outlet opening;
b) attaching a second end of the hose to the adapter;
c) attaching a first end of the hose to the outlet opening;
d) providing a smoke source to the smoker unit;
e) generating smoke from the smoke source; and
f) subjecting foodstuff to the smoke.

Such method may be particularly supported by the control unit of the household cooking appliance, and more particularly by a program stored in said control unit in the steps of e) generating smoke from the smoke source; and f) subjecting food stuff to the smoke.

In an advantageous embodiment of the inventive method, the method further comprises a step of activating an exhaust fan system of the household cooking appliance.

A person skilled in the art will immediately recognize that a household cooking appliance, particularly an oven, as known in the art is usually applied with an exhaust fan system, which can be advantageously be employed by the present invention.

For example, the exhaust fan system of the household cooking appliance can be activated before, during and/or after the smoking process to create a negative pressure inside the cavity. Such negative pressure may advantageously assist the functioning of the electric fan for supplying the smoke generated by the smoker unit to the outlet opening. Particularly, such negative pressure may additionally suck the smoke from the smoker unit to the outlet opening. Particularly, in embodiments according to which a filter is arranged in the system the additional negative pressure generated by the exhaust fan system may be advantageous in pressure equalization through the filter. Furthermore, the contact time of the smoke, flavour or aroma with the food can be controlled by activating the exhaust system. Particularly, the exhaust system may be advantageously used after the heating chamber is cold subsequently sucking in fresh air from the outside and/or capturing the residual smoke, flavour or aroma in the filter.

The system according to the present application advantageously allows smoking and/or curing of the foodstuff, particularly by providing a precise control of smoke amount, duration of smoking, temperature, relative humidity, and air and/or smoke speed into a household cooking appliance. This can be advantageously achieved with the system of the present application, and particularly in an embodiment according to which the household cooking appliance is an oven equipped with steam technology.

The control of relative humidity is advantageous for dry curing. Said dry curing is performed with defined humidity and temperature. The integration of a hygrometer into the system provides real time feedback to the control unit. A specific parameter can be created to supply and monitor humidity from the incorporated steam system. The dry curing is typically done at lower temperatures than the temperatures during smoke curing, since the temperature control for both heating and cooling is required for this process. If a cooling system is integrated, then cold smoking is possible. In particular, fish, cheese, bacon, etc. may be prepared by cold smoking. The cooling system is optional. The implementation of the smoking system may also include refrigeration devices or at least ovens with refrigeration capability.

The above described problems are also advantageously solved in a further aspect by a smoker unit according to claim 10. Such smoker unit is a smoker unit of the system according to the present invention, and may be advantageously manufactured and supplied as a part of the system or as an individual part. The embodiments, features and advantageous described in connection with the smoker unit according to the present invention thus shall also be understood to be respective embodiments, features and advantageous of the system according to the present invention, and vice versa.

The smoker unit is capable of generating smoke. Said smoke is generated in a heating chamber of the smoker unit. For this purpose a smoke source, for example wood, wood chips, a flavouring liquid, aromas or the like, can be provided to the heating chamber and being heated in the heating chamber to generate the smoke.

The smoker unit and the household cooking appliance of the present invention are configured such that the smoker unit is mountable to said household appliance for supplying smoke to said outlet opening. For this purpose, further elements such as smoke guiding elements, e.g. a tube, pipeline, guiding or receiving element, insulation means, or the like can be provided.

Particularly, if the outlet opening is arranged more distant from the smoker unit the smoke can be supplied to the outlet opening via a respectively arranged smoke guiding element, e.g. a hose or a pipeline. Such smoke-guiding element preferably is arranged and configured such that it connects the outlet opening and the smoker unit such that smoke generated by the smoker unit is supplied to the outlet opening. Thereby it is preferred that the electric fan is arranged and configured such that it is capable of sucking in air through smoker unit, particularly through the heating chamber, to enhance the burning or smouldering of the smoke source materials and transports the smoke, aroma or flavour to the outlet opening and thus to the food. The connection of the electric fan to the outlet opening, particularly a smoke guiding element, preferably is arranged behind a wall of the cavity. It is preferred that said connection can be made out of metal to withstand the high temperatures that can occur during a pyrolytic cleaning cycle. The outlet opening preferably is sealable to avoid smoke and odour transfer from the smoking, aroma or flavouring system, particularly the smoker unit, when the household cooking appliance is used for cooking or baking processes other than smoking, and/or if a food container is not connected to the outlet opening via a hose.

The term “smoke” as used herein, preferably refers to airborne solid and/or liquid particulates and gases emitted when a smoke source material undergoes combustion or pyrolysis, together with the quantity of air that is entrained or otherwise mixed into the mass. Such smoke source material may comprise any agent suitable to generate smoke by combustion or pyrolysis, which is useful as a flavouring agent and/or preservative of foodstuffs. In connection with the present invention, preferable smoke source materials comprise wood, wood chips, flavour liquids, dust, herbs, incense, aromas or the like.

Accordingly, when using the system of the present invention smoke is supplied to the foodstuff for curing, smoking, aroma or flavouring the foodstuff.

For this purpose, a smoke source material is put into the heating chamber of the smoker unit according to the present invention, supplied with heat from a heat source, and which then undergoes combustion or pyrolysis, thus generating the smoke. If the fan is operated, the smoke is sucked and supported to the outlet opening. Advantageously, the fan thereby generates an under-pressure in the heating chamber, supporting the combustion or pyrolysis reaction with fresh air and thus enhances the smouldering or burning of the smoke source material. Accordingly, the amount of smoke supplied to the outlet opening and the rate of pyrolysis or combustion can be advantageously controlled by the fan operation.

The smoker unit may be arranged at and/or connected to various positions of the household cooking appliance. Particularly preferred is an arrangement, which allows for an easy access and operation by the user.

In an advantageous embodiment of the inventive system, the smoker unit is arranged or arrangeable outside of the cavity, preferably outside of the cooking appliance. Such arrangement is advantageous, as the smoker unit is not subjected to the heat in the cavity during a cooking or baking process, particularly during a pyrolysis process.

In a preferred embodiment, the smoker unit is arranged at the front of the household cooking appliance. This allows an easy access and operation by the user. Particularly, the smoke source material can be charged or re-charged without opening the frontal door closing the cavity. The smoker unit may contain a tray or grid on which the smoke source material can be placed. Particularly such tray or grid may be arranged in or above the heating chamber. The tray or grid may comprise a central depression dimensioned to accept small amount of smoke source material capable of being pyrolyzed or smouldered to produce the necessary amount of smoke. The smoker unit, particularly the heating chamber, may comprise an opening at the upper side. The smoker unit, particularly the heating chamber, may be configured open or closable, e.g. by a lid, which allows a user to easily charge or re-charge the smoker unit with smoke source material.

The grid or tray may be detachably mounted to the smoker unit and/or the heating chamber, which advantageously facilitates cleaning and/or replacement. The heating chamber preferably is made out of a non-flammable material. In a preferred embodiment the smoker unit is tube-shaped, particularly pipe shaped. It is also preferred that the smoker unit is arranged such that in a stage in which the smoking process is carried out the smoker unit protrudes from the frontal side of the household cooking appliance. In an embodiment, the smoker unit is arranged retractable in the frontal side of the household appliance, in a respectively formed receiving, by a push/pull mechanism. This allows that the smoker unit can be pulled out for use, and if not in use be pushed into the receiving. Preferably, in a retractable stage the surface of the smoker unit and the surface of the household appliance form an even surface, which provides for an advantageous design and, moreover, prevents the smoker unit from being damaged. At the same time, such receiving provides for storage of the smoker unit, if not in use. In the pulled-out state the smoker unit may be charged with smoke source material by the user.

In a further advantageous embodiment of the inventive system, the smoker unit can be detachably mounted to the household cooking appliance. This particularly facilitates the cleaning and/or replacement of the smoker unit. Particularly, the smoker unit can be stored inside the household appliance, in respectively formed receiving or detached from the household cooking appliance, when it is not used.

In a further advantageous embodiment of the inventive system, the heating chamber comprises a heating element. Such heating element advantageously allows applying the heat to the smoke source material sufficient to generate smoke. Such heat element particularly may be an electrical heating element. More particularly, the heating element may advantageously be controlled by the control unit of the household cooking appliance. Alternatively, the smoke source material placed in the heating chamber can be heated by an external heat source, for example a flame provided by matches, a lighter or a cooking torch.

When the heating element is an electrical heater the temperature of the chamber can be measured and controlled to be able to release temperature specific smoke or aromas from the heated smoke source materials, e.g. wood, dust, herbs, incense, or the like.

In an alternative embodiment, the heating element may be configured comprising an ignition mechanism and, optionally, a fuel supply, e.g. a gas supply. This is particularly of advantage as the ignition can be controlled and programmed by the control unit. For example, the ignition mechanism may be formed as the ignition of a gas cigarette lighter or the electric ignition of a gas cooking hob or gas oven.

The smoker unit, particularly the heating chamber, may comprise a temperature control mechanism, for example, comprising a temperature sensor for detecting the temperature within the heating chamber and/or valves for regulating the air supply. Additionally, the electrical fan can be controlled to adjust the temperature within the heating chamber.

The household cooking appliance according to the system of the present invention preferably is an oven, more preferably an oven comprising a steam function, for example, a steam-cooking oven. The household cooking appliance may particularly comprise a steam generator for providing a steam function.

Such steam function advantageously provides a possibility to heat and generate separately the smoke according needs, particularly avoiding overheating and flame, providing a precise temperature control and allowing a refill of water or vapor to the smoke source material, e.g. wooden chips, also during the smoke process using the steam generator.

In a further advantageous embodiment of the inventive system, the smoker unit comprises a smell filter. Such smell filter advantageously avoids smell inside the kitchen during and after use of the smoker unit. The smell filter may be arranged and configured such that it is activated when the smoke process is activated or will be activated later during the process. Particularly, the smell filter may be configured and arranged such that it is activated and remains activated for a certain time after operating the smoker unit, i.e. in a time-controlled manner. Such activation and/or switching off of the smell filter may advantageously be controlled by the control unit of the household cooking appliance and/or a program stored therein, in dependence to the respective time period.

In a further advantageous embodiment of the inventive system, the smoker unit comprises a smoke detector.

Particularly, if a smell filter is comprised in the smoker unit the smell filter can be activated, remains activated until the smoke detector indicates smoke in cavity, i.e. in a smoke controlled manner. Such activation and/or switching off of the smell filter may advantageously be controlled by the control unit of the household cooking appliance and/or a program stored therein in dependence to the respective detection of the smoke detector.

Preferably, the smoke detector is arranged out of the cavity, since most smoke detectors are not heat resistant enough to withstand oven temperatures. For example, the smoke sensor can be situated in a cooling channel of the oven. Further, an optical smoke detector can be situated outside the cavity with a transparent bypass connected to the cavity inside to enable the sensor to measure the smoke inside the cavity. Preferably, the smell filter is situated between the cavity and the cooling fan or is arranged directly on the container lid.

A smoke detector in combination advantageously allows for a precise smoke regulation. The presence of smoke can be verified and the smoking process can be controlled more precisely than just through temperature control.

The system further comprises an electric fan arranged for supplying the smoke generated by the smoker unit to the outlet opening. Such fan is provided as a part of the system. Thereby the fan can be configured and arranged as a separate part or may also be advantageously configured as a part of the smoker unit or household cooking appliance thus forming an assembly part. The fan is configured and arranged such that it is capable of generating an airflow, which is sucking the smoke generated in the smoking unit, particularly in the heating chamber, and supplying said smoke to the outlet opening. For this purpose, it is preferable to arrange the fan in or at a smoke guiding element.

In a further aspect the present invention provides a hose according to claim 11. In some embodiments, the system according to the present invention may comprise such hose. Such hose may be advantageously manufactured and supplied as a part of the system or as an individual part. The embodiments, features and advantageous described in connection with the hose according to the present invention thus shall also be understood to be respective embodiments, features and advantageous of the system according to the present invention, and vice versa.

A hose according to the present invention is for supplying smoke from a smoker unit mounted to a household cooking appliance, into a food container. The hose comprises a first end and a second end, wherein the first end is configured to be attachable to the smoke outlet opening of the household cooking appliance of the system according to the present invention. The second end of the hose is configured to be attachable to an adapter of a food container, particularly a food container according to the present invention.

By connecting the hose with its first end to the smoke outlet opening of the household cooking appliance and its second end of the hose to an adapter of the food container, the hose thereby preferably establishes an essentially airtight connection between the outlet opening and the food container. The hose thus serves to guide the smoke from the outlet opening into the food container, and prevents that smoke enters the cavity of the household cooking appliance. Preferably, at least one end of the hose, more preferably both ends of the hose, are provided with an adapter means for connecting the respective end of the hose with either the adapter of the food container or the outlet opening. The outlet opening and/or the food container may be provided with such adapter for connecting the respective end of the hose. Thereby the adapter connections and respective adapters at the first end of the hose and the smoke outlet opening, and the second end of the hose and of the food container can be formed same or different. Additionally, at least one end of the hose and/or the adapters of the food container and/or the outlet opening may comprise a valve for preventing unwanted smoke release.

In a further advantageous embodiment of the inventive system, the system further comprises a hose, wherein a first end of said hose is connectable to the outlet opening, and wherein, preferably, a second end of said hose is connectable to a food container.

Such hose is preferably made from a flexible material, which allows a more flexible connection of the food container with the outlet opening and thus a more flexible placement of the food container. Particularly, the food container may be placed on a baking tray or grid, while the grid is pulled out from the cavity, which allows for a more convenient handling and access of the food container.

The hose according to the present invention allows transporting the smoke, aroma or flavours from the outlet opening to and into a food container, which holds the foodstuff to be smoked inside the oven. Particularly the electric fan sucks in air through the heating chamber to enhance the burning or smouldering of the smoke source materials, and transports the smoke, aroma or flavour through the hose into the container. In the container, it comes in contact with the foodstuff and settles on the surface of it to infuse the food with its aroma or cures the foodstuff.

In a further aspect the present invention provides a food container according to claim 12. In some embodiments, the system according to the present invention may comprise such food container. Such food container may be advantageously manufactured and supplied as a part of the system or as an individual part.

The embodiments, features and advantageous described in connection with the food container according to the present invention thus shall also be understood to be respective embodiments, features and advantageous of the system according to the present invention, and vice versa.

Such food container according to the present invention comprises a cooking vessel and a lid. The food to be smoked can be placed in the vessel and the container may be closed by the lid. Thereby the lid is capable of sealing the cooking vessel in an essentially airtight manner. This advantageously prevents an unwanted release of smoke from the container. The food container, preferably the lid, comprises an adapter configured to be connectable to the second end of a hose. The hose is used to supply smoke from the outlet opening into the food container. For this purpose, the first end of said hose is configured to be attachable to the smoke outlet opening.

The food container advantageously allows placing foodstuff to be smoked or cured into it, and thereby provides an essentially airtight smoking chamber. Moreover, the use of such food container advantageously allows for an odour-free oven cavity. The food container additionally is relatively easy to clean, and preferably be manufactured from a material, which allows for cleaning in a dishwasher.

In a further advantageous embodiment of the inventive system, the food container comprises an opening for pressure equalization. Such opening for pressure equalization preferably is arranged in the lid of the food container.

In a further advantageous embodiment of the inventive system, the food container comprises a filter element, for example a carbon filter. Such filter element allows for minimizing the smoke, aroma or flavours, which exit the food container. The container may also comprise a gasket. The food container, i.e. the lid and/or the vessel, and, preferably its secondary parts, for example the filter or gasket, preferably are manufactured from a temperature-stable material to allow cooking of the foodstuff with standard household cooking appliance heating or baking procedures with the standard heating elements of the household cooking appliance.

All described embodiments of the invention have the advantage, that the system according to the present invention allows the user to smoke or cure foodstuff without the need for an additional smoking appliance. By contrast, the system is adaptable to existing household coking appliances. Particularly, relatively small amounts of smoke source material can be used to create a sufficient amount of smoke to flavour or cure the foodstuff. Moreover, the present invention allows for controlling smoke amount, duration of smoke application, temperature, relative humidity, and airspeed in a household cooking appliance. Furthermore, according to embodiments applying a food container odours are kept inside the food container and the household cooking appliance is kept smell-free. Moreover, the exhaust fan system present in usual household cooking appliances can be advantageously used in connection with the system of the present invention. Still further, the present invention advantageously allows that smoke, flavours or aromas can be added in cold or warm temperatures. With the present invention foodstuff can be flavoured, smoked and/or cured without heating or with heat by the standard heating system of the household cooking appliance. The smoker unit of the present invention furthermore allows for an easy charging and re-charging of smoke source materials. Particularly, smoke, flavours or aromas can be administered more than one time. Moreover, different smoke source materials can be applied and combined in the smoker unit. The present invention also allows to advantageously using the control unit of the household cooking appliance, for example, for combination of smoke or aroma generation with a cooking program. The control system and/or the exhaust fan system of the appliance can advantageously be used to control contact time of smoke, flavour or aroma.

The system furthermore avoids strong smell in the room where the appliance is operated. Advantageously, the arrangement and configuration of the system reduces the risk of fire due to temperature control and arrangement and configuration of the smoker unit.

The present invention will be described in further detail with reference to the drawings from which further features, embodiments and advantages may be taken, and in which:

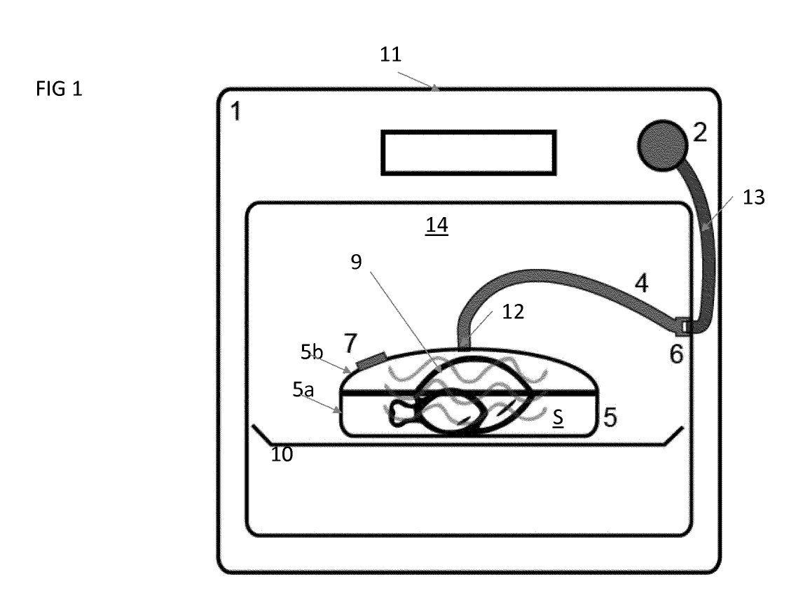

FIG. 1 illustrates a schematic frontal view of a household cooking appliance showing a first inventive embodiment; and

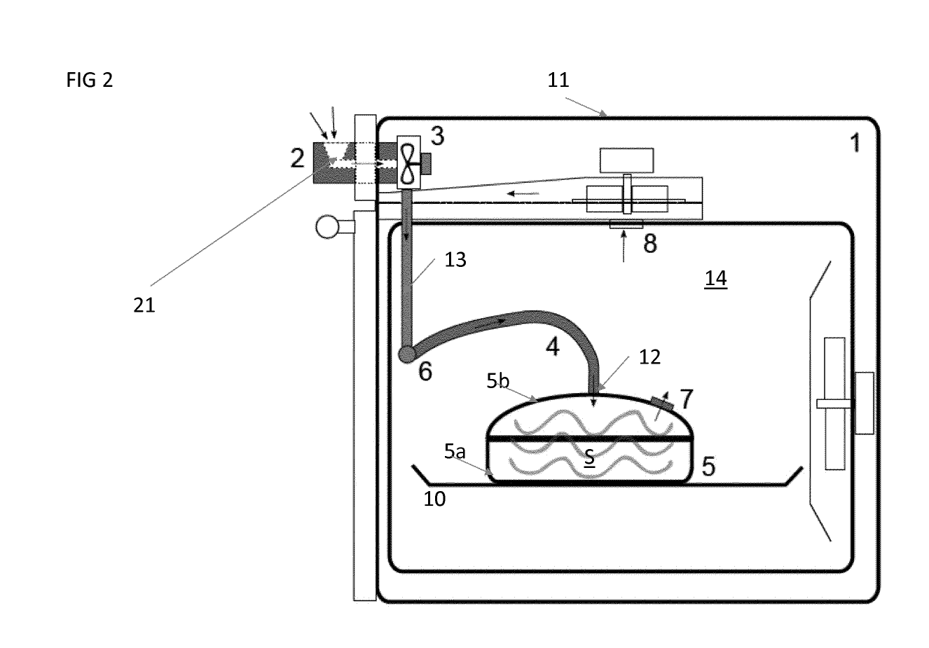

FIG. 2 illustrates a schematic sectional side view of the household cooking appliance according to the first inventive embodiment.

FIGS. 1 and 2 show a system for curing or flavouring foodstuff comprising a household appliance 1. The household cooking appliance 1 may in general be any household cooking appliance known in the art, which may be provided with the system according to the present invention. In the shown embodiment, the household cooking appliance is described by way of example in the form of an oven 1. Such household cooking appliance usually comprises an outer housing 11, comprising a cavity 14. The cavity 14 is formed by a rear wall, a bottom wall, an upper wall and two sidewalls, and comprises a central opening, which is closable by a frontal door. As apparent from FIGS. 1 and 2 an outlet opening 6 is arranged in a sidewall of the cavity 1. The cavity 14 is configured to store foodstuff 9, particularly comprised in a food container 5 placed on a grid or baking tray 10. The foodstuff 9 is shown in FIG. 1 only. The oven 1 usually comprises at least one heating system for heating the cavity 14, for example an electrical heating or gas heating system, and/or optionally a steam system. Such household cooking appliance furthermore usually comprises a control unit for controlling various functions of the appliance and a display and/or user interface to allow for displaying and/or input parameters of the processes to a used. The control unit of the oven 1 may also be configured to operate and/or control smoke supply to the outlet opening 6. Particularly, a household cooking appliance as known in the art is usually applied with an exhaust fan system 8, which can be advantageously be employed by the present invention, in that the exhaust fan system 8 is used to assist the smoking process, particularly be generating a negative pressure in the cavity 14.

The system further comprises a smoker unit 2 arranged at the frontal side of the oven 1. Here the smoker unit 2 is shown in a configuration where the smoker unit 2 partially protrudes from the frontal side of the oven 1. The smoker unit 2 is capable of generating smoke S, whereby the arrows in FIG. 2 depict the flow of smoke S.

As immediately apparent from FIGS. 1 and 2, the smoker unit 2 is arranged outside of the cavity 14. Particularly, the smoker unit 2 is arranged in a receiving formed in the frontal side of the outer housing of the oven 1 and can be detachably mounted to said receiving. The smoker unit 2 further comprises a heating chamber 21 and is configured and arranged mountable to the oven 1 for supplying smoke to said outlet opening 6. For this purpose the smoker unit 2 is connected to the outlet opening 6 by a smoke guiding element 13, here a tube. The system further comprises an electric fan 3, which is arranged at the rear side of the smoker unit 2 within the outer housing of the oven 1.

The heating chamber 21 of the smoker unit 2 may comprise a heating element for heating smoke source material provide to the smoker unit 2. Additionally or alternatively, the smoke source material can be heated by an external heat source, e.g. a flame. The smoker unit 2 may additionally comprise a smell filter.

In a smoking process, for example according to the method of the present invention, the fan 3 sucks the smoke S into the smoke guiding element 13 and thus supplies the smoke S generated by the smoker unit 2 to the outlet opening 6.

The food container 5 placed in the cavity 14 comprises a cooking vessel 5a and a lid 5b. The lid 5b is capable of sealing the cooking vessel 5a in an essentially airtight manner. The food container 5 additionally comprises a filter element 7, for example a carbon filter. The food container 5, in the shown embodiment the lid 5b, comprises an adapter 12 configured to be connectable to the second end of a hose 4.

The first end of said hose 4 is configured to be attachable to a smoke outlet opening 6, provided in a cavity wall of the oven 1, and its second end is configured to be attachable to the food container 5, particularly to the adapter 12. Accordingly, the hose 4 can be advantageously arranged such that its first end is connected to the outlet opening 6, and its second end is connected to the adapter 12 of the food container 5. Accordingly, smoke S is guided from the outlet opening 6 through the hose 4 into the container 5, thus allowing curing or smoking the foodstuff 9.

The food container 5 further comprises an opening for pressure equalization, not shown in the figure.

The features of the present invention disclosed in the specification, the claims, and/or the figures may both separately and in any combination thereof be material for realizing the invention in various forms thereof.

### LIST OF REFERENCE NUMERALS

1 household cooking appliance
2 smoker unit
21 heating chamber
3 electric fan
4 hose
5 food container
5a vessel
5b lid
6 outlet opening
7 filter element
8 exhaust fan system
9 foodstuff
10 grid or baking tray
11 outer housing
12 adapter
13 smoke guiding element
14 cavity
S smoke

1. A system for curing or flavouring foodstuff comprising:
a smoker unit capable of generating smoke and comprising a heating chamber;
a household cooking appliance comprising a cavity for storing foodstuff and/or a food container, the cavity having a smoke outlet opening for supplying smoke to the cavity, wherein the smoker unit is mountable to said household cooking appliance for supplying said smoke to said smoke outlet opening; and
an electric fan arranged for supplying the smoke generated by the smoker unit to the smoke outlet opening.

2. The system according to claim 1, wherein the smoker unit is arranged outside of the cavity.

3. The system according to claim 1, wherein the smoker unit can be detachably mounted to the household cooking appliance.

4. The system according to claim 1, wherein the heating chamber comprises a heating element.

5. The system according to claim 1, wherein the smoker unit comprises a smell filter.

6. The system according to claim 1, further comprising a hose, wherein a first end of said hose is connectable to the smoke outlet opening and a second end of said hose is connectable to a food container.

7. The system according to claim 6, further comprising a food container, comprising a cooking vessel and a lid, wherein the lid is capable of sealing the cooking vessel in an essentially airtight manner, and wherein the food container comprises an adapter configured to be connectable to the second end of the hose.

8. The system according to claim 6, wherein the food container comprises an opening for pressure equalization.

9. The system according to claim 1, wherein the household oven comprises a control unit configured to operate and/or control smoke supply to the smoke outlet opening.

10-13: (canceled)

14. A method for flavouring or curing foodstuff, comprising at least the following steps:
a) placing a food container having an adapter configured to be connectable to a first end of a hose into a cavity of a household cooking appliance comprising a smoker unit and a smoke outlet opening;
b) attaching a second end of the hose to the adapter;
c) attaching the first end of the hose;
d) providing a smoke source to the smoker unit;
e) generating smoke from the smoke source; and
f) subjecting foodstuff to the smoke.

15. The method according to claim 14 further comprising a step of activating an exhaust fan system of the household cooking appliance.

16. A system for smoking foodstuff comprising a household cooking appliance having a cooking cavity with a front opening closable by a door, a smoke outlet disposed in a side wall of said cooking cavity, an exhaust fan operable to generate a negative pressure in said cooking cavity, a smoker unit mounted at a front portion of said cooking appliance and disposed outside said cooking cavity in such a manner that when not in use the smoker unit can be adapted so that it does not protrude from the front of said cooking appliance, said smoker unit comprising a heating chamber accessible from outside said smoker unit so that said heating chamber can be recharged of smoke-source material without opening said door, said heating chamber being in fluid communication with said smoke outlet of said cooking cavity for delivering smoke generated in said heating chamber to said smoke outlet, a heating element adjacent to said heating chamber and configured to generate heat for combustion or pyrolysis of smoke-source material in said heating chamber to generate smoke therefrom, a smoker fan arranged and configured to suck air through said heating chamber to enhance burning or smouldering of said smoke-source material therein and to transport said smoke to said smoke outlet of said cooking chamber, and a controller operable according to a predetermined program to regulate said heating element, said smoker fan and said exhaust fan to control the generation and delivery of smoke to said smoke outlet of said cooking chamber to execute a smoking operation for a foodstuff in said cooking chamber, said smoke outlet of said cooking chamber being closable when not in use for smoking a foodstuff within the cooking chamber.

17. The system according to claim 16, said smoker unit being removably mounted to the front of said cooking appliance such that when not in use, the smoker unit can be removed from the cooking appliance so that it does not protrude therefrom.

18. The system according to claim 16, said smoker unit being retractable into a receiving space located at the front of said cooking appliance such that when not in use, the smoker can be retracted into said receiving space so that it does not protrude from the front of the appliance.

19. The system according to claim 17, further comprising food container receivable within the cooking chamber and adapted to receive a foodstuff therein for smoking the foodstuff, the food container comprising a cooking vessel and a lid effective to seal the cooking vessel, and a flexible hose releasably connected at a first end to said smoke outlet of said cooking chamber and at a second end to said food container within said cooking chamber for delivering smoke to said food container, wherein the cooking chamber outside said food container is isolated from smoke generated in said smoker unit for smoking a foodstuff in said food container within the cooking chamber.

20. The system according to claim 18, further comprising food container receivable within the cooking chamber and adapted to receive a foodstuff therein for smoking the foodstuff, the food container comprising a cooking vessel and a lid effective to seal the cooking vessel, and a flexible hose releasably connected at a first end to said smoke outlet of said cooking chamber and at a second end to said food container within said cooking chamber for delivering smoke to said food container, wherein the cooking chamber outside said food container is isolated from smoke generated in said smoker unit for smoking a foodstuff in said food container within the cooking chamber.
